(19) United States
(12) Patent Application Publication
(10) Pub. No.: US 2012/0036459 A1
(43) Pub. Date: Feb. 9, 2012

(54) Apparatuses and Methods for Arranging and Manipulating Menu Items

(75) Inventors: Cheng-Yu Pei, Taipei City (TW); Yan He, Beijing (CN)

(73) Assignee: MEDIATEK INC., Hsin-Chu (TW)

(21) Appl. No.: 13/052,786

(22) Filed: Mar. 21, 2011

Related U.S. Application Data
(60) Provisional application No. 61/370,558, filed on Aug. 4, 2010.

(51) Int. Cl. G06F 3/048

(52) U.S. Cl. 715/765; 715/810; 715/815

(57) ABSTRACT

An electronic interaction apparatus is provided with a processing unit. The processing unit configures a touch screen to display a first set of the menu items in a first row on the touch screen, and to display a second set of the menu items in a second row on the touch screen. Particularly, the first row is lower than the second row, and the menu items in the second set are smaller than the menu items in the first set.

### CROSS REFERENCE TO RELATED APPLICATIONS

This Application claims the benefit of U.S. Provisional Application No. 61/370,558, filed on Aug. 4, 2010, the entirety of which is incorporated by reference herein.

### BACKGROUND OF THE INVENTION

1. Field of the Invention

The invention generally relates to management of menu items, and more particularly, to apparatuses and methods for arranging and manipulating menu items in a virtual 3D space.

2. Description of the Related Art

To an increasing extent, display panels are being used for electronic devices, such as computers, mobile phones, media player devices, and gaming devices, etc., as human-machine interfaces. The display panel may be a touch panel which is capable of detecting the contact of objects thereon, wherein users may interact with the touch panel by using pointers, styluses, or their fingers, etc. Also, the display panel may be provided with a graphical user interface (GUI) for users to view the menu items representing installed or built-in applications or widgets. Generally, the size of a display panel of an electronic device is designed to be small, and the number of menu items may be more than what the display panel may be capable of displaying. To solve this problem, the menu items may be divided into groups, so that the display panel may display one specific group of menu items at a time.

FIG. 1 shows a schematic diagram of a conventional arrangement of menu items. As shown in FIG. 1, a total number of 50 menu items (denoted as MI-1 to MI-50) are divided into 4 groups, wherein each group is displayed in a respective page. The 4 pages may be configured in a horizontal manner, in which the user has to flip on the display panel from the right to the left to turn to a next page, or alternatively, the 4 pages may be configured in a vertical manner, in which the user has to flip on the display panel from the bottom to the top to turn to a next page. Since the arrangement only provides a limited view for all menu items on the display panel, the user may need to turn the pages time after time if he/she wants to find one particular menu item among them all, and obviously, the page turning is time-consuming, resulting in more battery power consumption. Thus, it is needed to have an efficient and intuitive way of arranging menu items, so that more menu items may be displayed on the display panel to avoid the battery power consumption in page turning.

### BRIEF SUMMARY OF THE INVENTION

Accordingly, embodiments of the invention provide apparatuses and methods for arranging menu items in a virtual 3D space. In one aspect of the invention, an electronic interaction apparatus comprising a processing unit is provided for arranging a plurality of menu items in a virtual 3D space. The processing unit configures a touch screen to display a first set of the menu items in a first row on the touch screen, and to display a second set of the menu items in a second row on the touch screen, wherein the first row is lower than the second row, and the menu items in the second set are smaller than the menu items in the first set.

In another aspect of the invention, a method for arranging menu items in a virtual 3D space is provided. The method comprises the steps of displaying a first set of the menu items in a first row on a touch screen of an electronic interaction apparatus, and displaying a second set of the menu items in a second row on the touch screen, wherein the first row is lower than the second row, and the menu items in the second set are smaller than the menu items in the first set.

In one aspect of the invention, an electronic interaction apparatus comprising a processing unit is provided for arranging menu items in a virtual 3D space. The processing unit detects a touch or approximation of an object on a touch screen, and configures the touch screen to display a plurality of menu items. Also, the processing unit launches an application corresponding to one of the menu items in response to the touch or approximation of the object being detected on or near to the one of the menu items, wherein the menu items are arranged along a clockwise or counter-clockwise and upward or downward path on a surface of a virtual object.

In another aspect of the invention, a method for arranging menu items in a virtual 3D space is provided. The method comprises the steps of displaying a plurality of menu items on a touch screen of an electronic interaction apparatus, and launching an application corresponding to one of the menu items in response to the touch or approximation of the object being detected on or near to the one of the menu items, wherein the menu items are arranged along a clockwise or counter-clockwise and upward or downward path on a surface of a virtual object.

In one aspect of the invention, an electronic interaction apparatus comprising a processing unit is provided for arranging menu items in a virtual 3D space. The processing unit detects a touch or approximation of an object on a touch screen, and configures the touch screen to display a plurality of launchable and non-launchable menu items along a path on a surface of a virtual object on the touch screen. Also, the processing unit launches an application corresponding to one of the launchable menu items in response to the touch or approximation of the object being detected on or near to the one of the launchable menu items, and configures the touch screen to move all of the launchable and non-launchable menu items for a distance along the path in response to the touch or approximation of the object being detected on or near to the one of non-launchable menu items.

In another aspect of the invention, a method for arranging menu items in a virtual 3D space is provided. The method comprises the steps of displaying a plurality of launchable and non-launchable menu items along a path on a surface of a virtual object on a touch screen of an electronic interaction apparatus, launching an application corresponding to one of the launchable menu items in response to a touch or approximation of an object being detected on or near to the one of the launchable menu items, obtaining a first index of one of the non-launchable menu items in response to the touch or approximation of the object being detected on or near to the one of the non-launchable menu items, obtaining a second index of one of the launchable menu items for the one of the non-launchable menu items, and moving all of the menu items for a distance along the path corresponding to a difference between the first index and the second index.

Other aspects and features of the present invention will become apparent to those with ordinarily skill in the art upon review of the following descriptions of specific embodiments of the apparatus and methods for arranging menu items in a virtual 3D space.

### BRIEF DESCRIPTION OF DRAWINGS

The invention can be more fully understood by reading the subsequent detailed description and examples with references made to the accompanying drawings, wherein:

FIG. 1 shows a schematic diagram of a conventional arrangement of menu items;

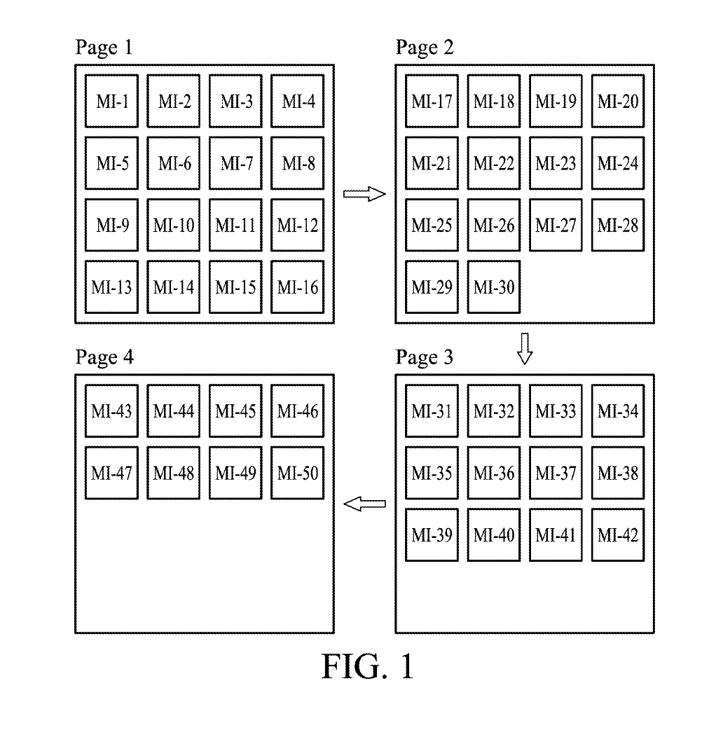

FIG. 2 shows a block diagram of a mobile phone according to an embodiment of the invention;

FIG. 3 shows an exemplary arrangement of menu items on the touch screen 26 according to an embodiment of the invention;

FIG. 4 shows an exemplary diagram illustrating the relationship between the menu items and the vanishing lines/point according to an embodiment of the invention;

FIG. 5 shows a schematic diagram of a single touch with a signal S501 corresponding to a location 501 according to an embodiment of the invention;

FIG. 6 shows a schematic diagram of a downward drag event with signals S601 to S603 corresponding to locations 601 to 603, respectively, according to an embodiment of the invention;

FIG. 7 shows an exemplary arrangement of menu items on the touch screen 26 according to another embodiment of the invention;

FIG. 8 shows an exemplary path on the surface of a virtual cylinder according to the embodiment shown in FIG. 7;

FIGS. 9A and 9B show exemplary areas of a virtual cylinder from a top view for classifying launchable and non-launchable menu items according to embodiments of the invention;

FIG. 10 shows an exemplary arrangement of menu items on the touch screen 26 according to yet another embodiment of the invention;

FIG. 11 shows an exemplary path on the surface of a virtual downward cone according to the embodiment shown in FIG. 10;

FIGS. 12A and 12B show exemplary areas of a virtual downward cone from a top view for classifying launchable and non-launchable menu items according to embodiments of the invention;

FIG. 13 shows a flow chart of the method for arranging menu items in a virtual 3D space according to an embodiment of the invention; and

FIG. 14 shows a flow chart of the method for arranging menu items in a 3D virtual space according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

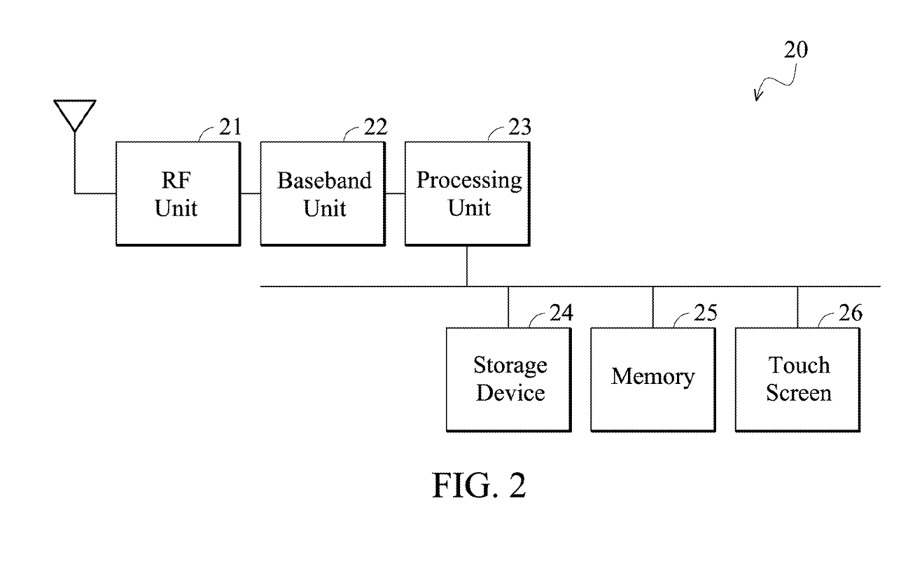

FIG. 2 shows a block diagram of a mobile phone according to an embodiment of the invention. The mobile phone 20 is equipped with a Radio Frequency (RF) unit 21 and a Baseband unit 22 to communicate with a corresponding node via a cellular network. The Baseband unit 22 may contain multiple hardware devices to perform baseband signal processing, including analog to digital conversion (ADC)/digital to analog conversion (DAC), gain adjusting, modulation/demodulation, encoding/decoding, and so on. The RF unit 21 may receive RF wireless signals, convert the received RF wireless signals to baseband signals, which are processed by the Baseband unit 22, or receive baseband signals from the Baseband unit 22 and convert the received baseband signals to RF wireless signals, which are later transmitted. The RF unit 21 may also contain multiple hardware devices to perform radio frequency conversion. For example, the RF unit 21 may comprise a mixer to multiply the baseband signals with a carrier oscillated in the radio frequency of the wireless communications system, wherein the radio frequency may be 900 MHz, 1800 MHz or 1900 MHz utilized in GSM systems, or may be 900 MHz, 1900 MHz or 2100 MHz utilized in WCDMA systems, or others depending on the radio access technology (RAT) in use. The mobile phone 20 is further equipped with a touch screen 26 as part of a man-machine interface (MMI). The MMI is the means by which people interact with the mobile phone 20. The MMI may contain screen menus, icons, text messages, and so on, as well as physical buttons, a keypad and the touch screen 26, and so on. The touch screen 26 is a display screen that is sensitive to the touch or approximation of a finger or stylus. The touch screen 26 may be a resistive or capacitive type, or others. Users may manually touch, press, or click the touch screen to operate the mobile phone 20 with the indication of the displayed menus, icons or messages. A processing unit 23 of the mobile phone 20, such as a general-purposed processor or a micro-control unit (MCU), or others, and loads and executes a series of program codes from a memory 25 or a storage device 24 to provide MMI functions for users. It is to be understood that the introduced method for rearranging menu items may be applied to different electronic apparatuses, such as portable media players (PMP), global positioning system (GPS) navigation devices, portable gaming consoles, and so on, without departing from the spirit of the invention.

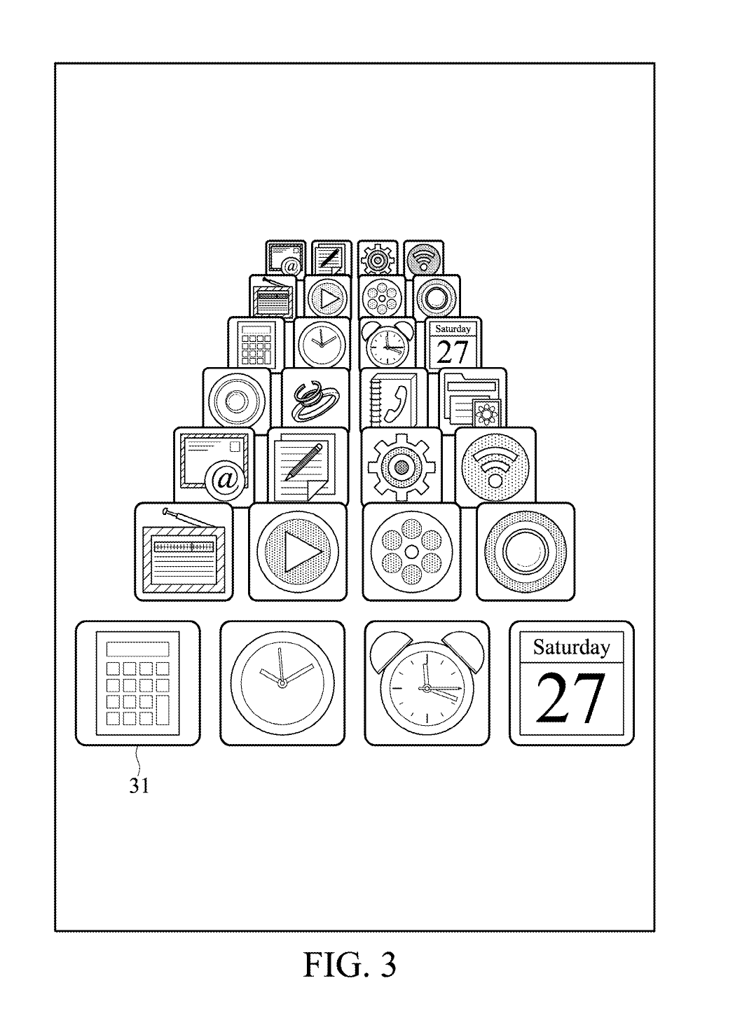

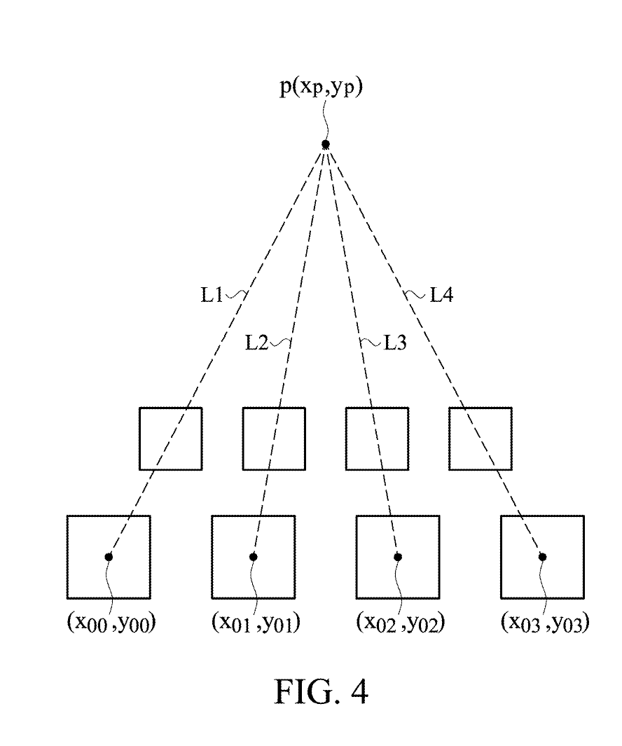

To further clarify, the touch screen 26 provides visual presentations of menu items for installed or built-in applications or widgets of the mobile phone 20. The menu items may be divided into a plurality of sets, and each set of menu items is displayed in a respective row on the touch screen 26. FIG. 3 shows an exemplary arrangement of menu items on the touch screen 26 according to an embodiment of the invention. As shown in FIG. 3, the arrangement provides 7 sets of menu items to be displayed on the touch screen 26, wherein each set contains 4 menu items and is arranged in a respective row. Thus, the arrangement allows a total number of 28 menu items to be displayed on the touch screen 26 at one time. Particularly, the rows are piled up from the bottom to the top of the touch screen 26 and the menu items in a higher row are smaller than those in a lower row. That is, the first row is lower than the second row and the menu items in the second row (i.e. the menu items in the second set) are smaller than the menu items in the first row (i.e. the menu items in the first set), the second row is lower than the third row and the menu items in the third row (i.e. the menu items in the third set) are smaller than the menu items in the second row (i.e. the menu items in the second set), and so on, such that a 3D virtual space is created as if the menu items in the front row are rendered to be closer to the user and the menu items in the back row are rendered to be further away from the user. Specifically, the menu items with the same horizontal sequential order in different rows are arranged in a vanishing line (denoted as L1 to L4) to a vanishing point p, as shown in FIG. 4. In order to do so, the processing unit 23 may first determine the positions of the menu items in the first row and the vanishing point p. For each one of the menu items in the first row, a corresponding vanishing line may then be determined Assume that the coordinates of the vanishing point p is (xₚ,yₚ), and the coordinates of the menu items of the first row, from left to right, are (x₀₀,y₀₀), (x₀₁,y₀₁), (x₀₂,y₀₂), and (x₀₃,y₀₃), wherein y₀₀=y₀₁=y₀₂=y₀₃ since they are in the same row. Therefore, the functions of the vanishing lines L1 to L4 may be calculated as follows:

$$\begin{matrix}x = ( \frac{{x}_{p} - {x}_{00}}{{y}_{p} - {y}_{00}} ) ( y - {y}_{00} ) + {x}_{00} , & L 1 \\ x = ( \frac{{x}_{p} - {x}_{01}}{{y}_{p} - {y}_{01}} ) ( y - {y}_{01} ) + {x}_{01} , & L2 \\ x = ( \frac{{x}_{p} - {x}_{02}}{{y}_{p} - {y}_{02}} ) ( y - {y}_{02} ) + {x}_{02} , & L3 \\ x = ( \frac{{x}_{p} - {x}_{03}}{{y}_{p} - {y}_{03}} ) ( y - {y}_{03} ) + {x}_{03} . & L4\end{matrix}$$

It is to be understood that the first 2 rows depicted in FIG. 4 are given as an exemplary arrangement of the rows of menu items, and for those skilled in the art, there may be more rows above the depicted 2 rows according to the same manner as described above.

Subsequently, the processing unit 23 may determine a plurality of first ratios R1ᵢ and a plurality of second ratios R2ᵢ for arranging the menu items in the subsequent (or upper) rows along the vanishing lines, wherein R1ᵢ represents the ratio of the distance between the menu items in the first and the i-th row to the total distance between the menu items in the first row and the vanishing point p, and R2ᵢ represents the ratio of the size of the menu items in the i-th row to the size of the menu items in the first row. In one embodiment, the first ratios R1ᵢ and the second ratios R2ᵢ may be determined to be constant increments. For example, constant incremental ratios R1ᵢ and R2ᵢ for the case where the number of rows to be displayed is 7 are given as follows in Table 1.

TABLE 1

| | Row Index (i) | | | | | | |
|---|---|---|---|---|---|---|---|
| | 1 | 2 | 3 | 4 | 5 | 6 | 7 |
| R1ᵢ | 0 | 0.1 | 0.2 | 0.3 | 0.4 | 0.5 | 0.6 |
| R2ᵢ | 1 | 0.9 | 0.8 | 0.7 | 0.6 | 0.5 | 0.4 |

In another embodiment, the first ratios R1ᵢ and the second ratios R2ᵢ may be determined according to a geometric progression, such as a Finite Impulse Response (FIR) Approximation, in which the growth of the ratios decreases as the row index increases. For example, ratios R1ᵢ and R2ᵢ determined using a geometric progression for the case where the number of rows to be displayed is 7 are given as follows in Table 2.

TABLE 2

| | Row Index (i) | | | | | | |
|---|---|---|---|---|---|---|---|
| | 1 | 2 | 3 | 4 | 5 | 6 | 7 |
| R1ᵢ | 0 | 0.3 | 0.55 | 0.65 | 0.7 | 0.75 | 0.8 |
| R2ᵢ | 1 | 0.7 | 0.45 | 0.35 | 0.3 | 0.25 | 0.2 |

In still another embodiment, the first ratios R1ᵢ and the second ratios R2ᵢ may be predetermined in a lookup table. Based on the ratios R1ᵢ the positions of the menu items in the subsequent (or upper) rows may be determined using the functions of the vanishing lines L1 to L4 and the positions of the menu items in the first row and the vanishing point p. Lastly, the processing unit 23 may reduce the menu items in the subsequent (or upper) rows based on the second ratios R2ᵢ and display the reduced menu items on the touch screen 26 according to the arranged positions. An exemplary pseudo code for arranging the menu items according to an embodiment of the invention is addressed below.

```
ArrangingMenuItems Algorithm
{
    Define positions of the menu items in the 1^{st} row and the vanishing point p;
    //items_count_in_a_row represents the number of menu items in a row
    For (i = 0; i < items_count_in_a_row; i++)
    {
        Generate the i-th line function of the i-th vanishing line from the center of the i-
    th menu item in the 1^{st} row to the vanishing point p;
    }
    //visible_row_count represents the number of rows to be displayed
    For (i = 0; i < visible_row_count; i++)
    {
        Calculate the ratio R1ᵢ of the distance between the menu items in the 1^{st} row and
    the (2+i)-th row to the total distance between the menu items in the 1^{st} row and the
    vanishing point p;
        Calculate the ratio R2ᵢ of the size of the menu items in the (2+i)-th row to the
    size of the menu items in the 1^{st} row;
    }
    //begin_visible_index represents the 1^{st} row index among the rows to be displayed
    For (j = begin_visible_index; j < begin_visible_index + visible_row_count−1; j++)
    {
        For (i = 0; i < items_count_in_a_row; i++)
        {
            k = j − begin_visible_index;
            Calculate the position of the center of the i-th menu item in the k-th row
        according to the position of the center of the i-th menu item in the 1^{st} row, the i-
        th line function, and the ratio R1ₖ;
            Resize the i-th menu item in the k-th row according to the ratio R2ₖ;
        }
    }
    Display the menu items from the last to the first visible rows according to the
calculated positions of the centers of the menu items and the resizing results;
}
```

The information regarding the arrangement of the menu items may be maintained using data structures to indicate the relationships between the menu items and the rows. A first table may be used to store the profile data, such as the icon images, the displayed texts, and others, of all of the menu items for the installed or built-in applications or widgets of the mobile phone 20, as shown below in Table 3.

TABLE 3

| Index | Image | Text | Others |
|---|---|---|---|
| MenuItem1 | Image1 | YouTube | . . . |
| . | . | . | . |
| . | . | . | . |
| . | . | . | . |
| MenuItem5 | Image5 | Calculator | . . . |
| MenuItem6 | Image6 | Clock | . . . |
| MenuItem7 | Image7 | Alarm | . . . |
| MenuItem8 | Image8 | Calendar | . . . |
| . | . | . | . |
| . | . | . | . |
| . | . | . | . |

The “Index” field indicates the index of a menu item among all menu items, the “Image” field may store bitmap data of an icon image or a file directory pointing to where actual bitmap data of an icon image is stored, and the “Text” field indicates the title of a menu item. The “Others” field indicates supplementary information concerning a menu item, such as the type of the installed or built-in application or widget, the address of the installed or built-in application or widget in the storage medium, the execution parameters, and so on. Additionally, a second table may be used to store the information of the rows, as shown below in Table 4.

TABLE 4

| | MenuItem | MenuItem | MenuItem | MenuItem |
|---|---|---|---|---|
| Raw Index | Index1 | Index2 | Index3 | Index4 |
| 1 | MenuItem1 | MenuItem2 | MenuItem3 | MenuItem4 |
| [symbol] | [symbol] | [symbol] | [symbol] | [symbol] |
| [symbol] | [symbol] | [symbol] | [symbol] | [symbol] |
| [symbol] | [symbol] | [symbol] | [symbol] | [symbol] |
| [symbol] | [symbol] | [symbol] | [symbol] | [symbol] |
| [symbol] | [symbol] | [symbol] | [symbol] | [symbol] |
| [symbol] | [symbol] | [symbol] | [symbol] | [symbol] |
| [symbol] | [symbol] | [symbol] | [symbol] | [symbol] |
| 9 | MenuItem33 | MenuItem34 | MenuItem35 | MenuItem36 |
| . | . | . | . | . |
| . | . | . | . | . |
| . | . | . | . | . |

Among all rows, the visible ones are marked in bold and italic, indicating which rows are visible on the touch screen 26. Here, a variable “visible_row_count” may be configured to be 7, indicating the total number of visible rows, and a variable “begin_visible_index” may be configured to be 2, indicating that the visible rows start from the second row. After determining which rows are visible, the processing unit 23 may obtain the information of the menu items in the visible rows according to their menu item indices. For software implementation, Table 3 and Table 4 may be established using multi-dimensional arrays, linked lists, or others. Note that, Table 3 and Table 4 may alternatively be integrated into a single table, and the invention should not be limited thereto.

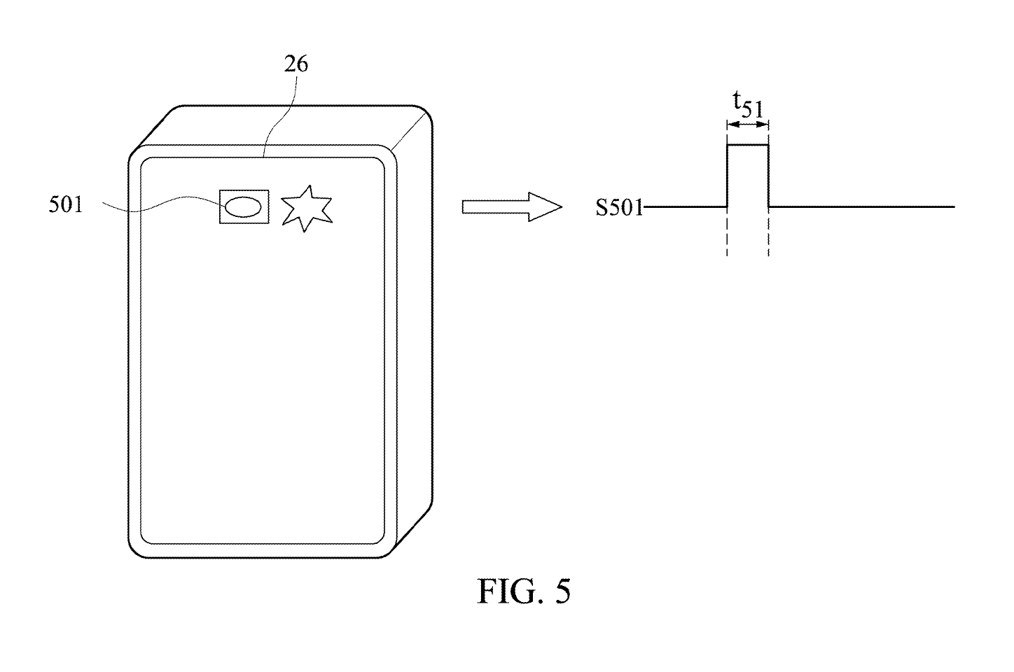

With the arrangement as described above, the user is provided an intuitive and efficient view of the menu items. Later, when the user wants to launch a corresponding application, he/she may trigger a touch event on the position of a corresponding menu item on the touch screen 26. When the touch screen 26 detects a touch or approximation of an object on or near to one of the displayed menu items, the processing unit 23 launches an application corresponding to the touched or approximated menu item. For example, if the touched or approximated menu item is the first menu item to the left 31 in the first visible row as shown in FIG. 3, the processing unit 23 searches Table 4 to obtain the index of the selected menu item and use the index to obtain corresponding information of the selected menu item. Then, the processing unit 23 launches the application according to the obtained information of the selected menu item. FIG. 5 shows a schematic diagram of a single touch with a signal S501 corresponding to a location 501 according to an embodiment of the invention. The signal S501 becomes true for a certain amount of time t₅₁ when a touch or approximation of an object is detected on the location 501 of the touch screen 23, otherwise, it becomes false. A successful single touch is determined when the time period t₅₁ is limited within a predetermined interval.

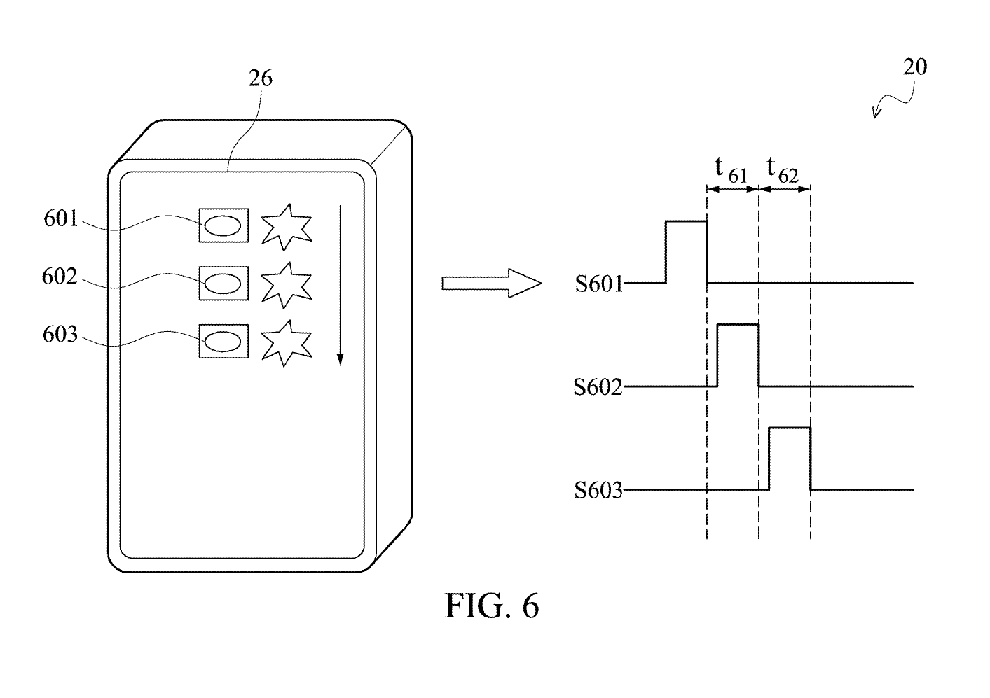

In addition, the processing unit 23 provides ways of manipulating the menu items via the touch screen 26, accompanying with the arrangement as described with respect to FIG. 4. If a user wishes to view the menu items not in the visible rows, he/she simply needs to trigger a drag event, or so-called pen-move event or slide event, on the touch screen 26. When the touch screen 26 detects a continuous touch or approximation of an object thereon, a drag event is identified. FIG. 6 shows a schematic diagram of a downward drag event with signals S601 to S603 corresponding to locations 601 to 603, respectively, according to an embodiment of the invention. The continuous touch is detected via the sensors placed on or under the locations 601 to 603 of the touch screen 26. The time interval t₆₁ between the terminations of the first and second touch detections, and the time interval t₆₂ between the terminations of the second and third touch detections are obtained by the processing unit 23. Particularly, the drag event is determined by the processing unit 23 when detecting each of the time intervals t₆₁ and t₆₂ is limited within a predetermined time interval. The drag events in other directions, such as upward, leftward, and rightward can be determined in a similar way, and are omitted herein for brevity. Next, the processing unit 23 determines whether the direction of the drag event is upward or downward. If the direction of the drag event is upward, the processing unit 23 configures the touch screen 26 to update the visible rows and make all of the displayed menu items being moved upward together. That is, one or more originally displayed rows closer to the top of the touch screen 26, or at the farthest end in the virtual 3D perspective, may be moved out of the touch screen 26 and become invisible, while one or more invisible rows with indices prior to the index of the originally lowest visible row, or the originally nearest visible row in the virtual 3D perspective, may be displayed at the bottom of the touch screen 26 and become visible. As to exactly how many rows to be excluded from the touch screen 26 and to be added into the touch screen 26, the processing unit 23 needs to determine how long the drag event had elapsed, defined as a first duration. After that, the distance between the original positions of the menu items and the destination positions of the menu items may be determined for the upward movement, according to the first duration and a predetermined duration of how long the menu items should be moved from one row to another. For example, if the predetermined duration indicates that moving of a menu item from one row to another for a menu item requires 0.2 second and the first duration indicates that the drag event had elapsed for 0.4 seconds, then moved distance may be determined to be 2 rows upward or downward. An exemplary pseudo code for moving the menu items upward or downward according to an embodiment of the invention is addressed below.

```
MovingMenuItems Algorithm
{
    t0 = predetermined duration of how long the menu items should be moved from one
row to another;
    t1 = duration of how long the drag event d_evnt had elapsed;
    N = t1/t0;
    //begin_visible_index represents the 1^{st} row index among the rows to be displayed
    For (j = begin_visible_index; j < begin_visible_index + visible_row_count; j++)
    {
        //items_count_in_a_row represents the number of menu items in a row
        For (i = 0; i < items_count_in_a_row; i++)
        {
            k = j − begin_visible_index;
            if (d_evnt.direction == upward)
            {
                k = k − N;
            } else if (d_evnt.direction == downward)
            {
                k = k + N;
            }
            Calculate the position of the center of the i-th menu item in the k-th row
        according to the position of the center of the i-th menu item in the 1^{st} row, the i-
        th line function, and the ratio R1ₖ;
            Resize the i-th menu item in the k-th row according to the ratio R2ₖ;
        }
    }
    Display the menu items from the last to the first visible rows according to the
calculated positions of the centers of the menu items and the resizing results;
}
```

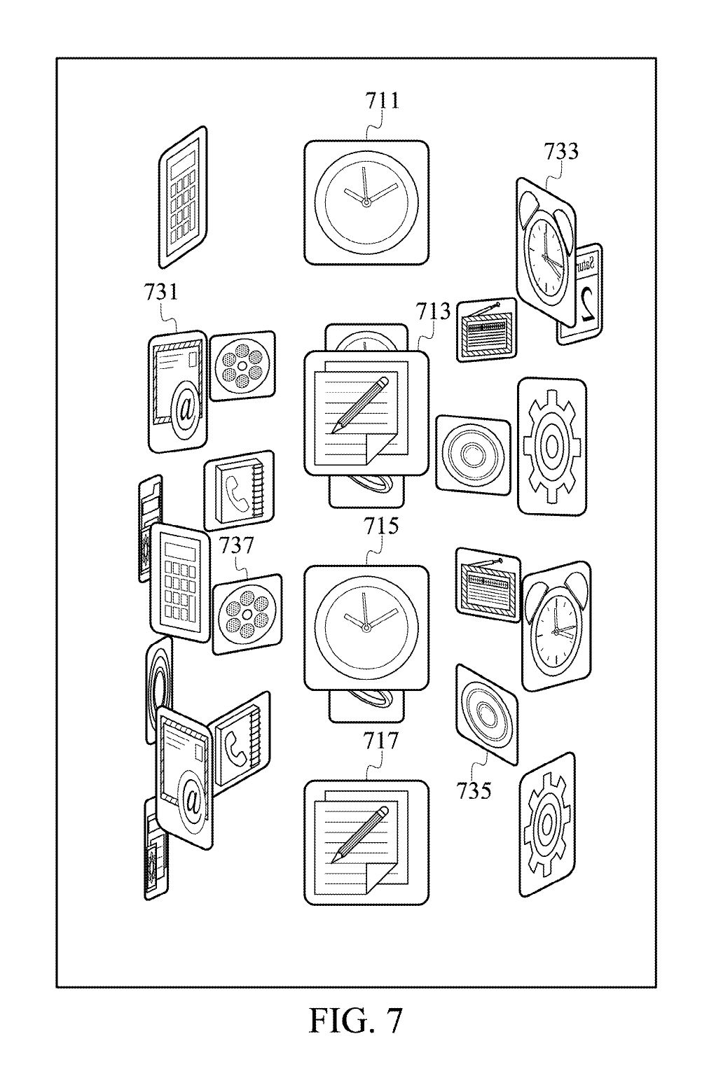

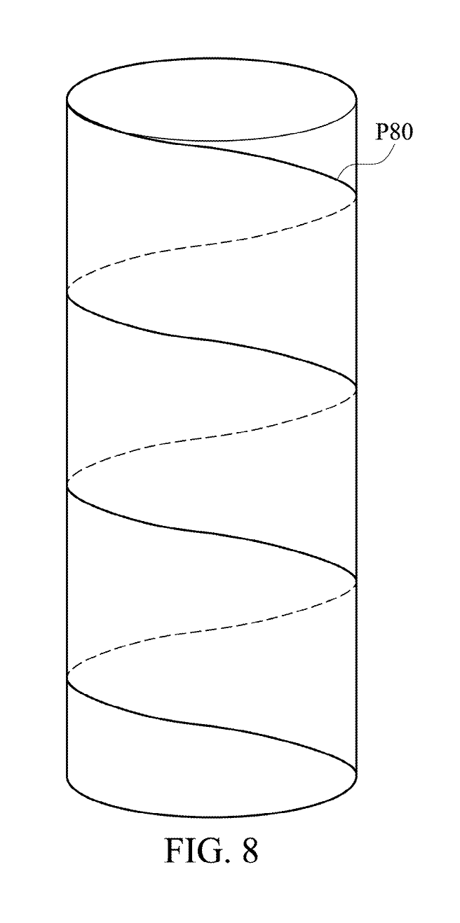

In addition to the virtual 3D arrangement of menu items as described in FIG. 3, the invention provides alternative arrangements which also facilitate intuitive and efficient viewing of menu items. FIG. 7 shows an exemplary arrangement of menu items on the touch screen 26 according to another embodiment of the invention. In this embodiment, the menu items are arranged along a counter-clockwise and downward path on the surface of a virtual cylinder. FIG. 8 shows an exemplary path P80 on the surface of a virtual cylinder according to the embodiment shown in FIG. 7. Particularly, the menu items displayed in the central column on the touch screen 26 are flat, for example, icons 711, 713, 715 or 717, while the menu items displayed elsewhere are skewed, for example, icons 731, 733, 735 or 737, as if the menu items are appended to the surface of the virtual cylinder. The menu items not displayed in the central column on the touch screen 26 are shadowed and/or resized according to the distances from the menu items in the central column on the touch screen 26. When a user wants to select one of the displayed menu items to launch the corresponding application, he/she may trigger a touch event on the position of the corresponding menu item on the touch screen 26. When the touch screen 26 detects a touch or approximation of an object on or near to one of the displayed menu items, the processing unit 23 launches an application corresponding to the touched or approximated menu item. Later, if the user wishes to view the menu items not displayed on the touch screen 26, he/she simply needs to trigger a drag event, or so-called pen-move event or slide event, on the touch screen 26. When the touch screen 26 detects a continuous touch or approximation of an object thereon, a drag event is identified, and the processing unit 23 determines whether the direction of the drag event is upward or downward. If the direction of the drag event is upward, the processing unit 23 moves all of the displayed menu items upward and clockwise for a distance along the path P80 on the surface of the virtual cylinder. Otherwise, if the direction of the drag event is downward, the processing unit 23 moves all of the displayed menu items downward and counter-clockwise for a distance along the path P80 on the surface of the virtual cylinder. As to the determination of the distance during the upward and downward movement, the processing unit 23 may first determine the duration of how long the drag event had elapsed, and then determine the distance between the original positions of the menu items and the destination positions of the menu items for the upward or downward movement according to a predetermined duration of how long the menu items should be moved from one position to another on the path P80. For example, if the predetermined duration indicates that moving of a menu items from one position to another on the path P80 requires 0.2 second and the detected duration of the drag event indicates that the drag event had elapsed for 0.4 second, then the moved distance may be determined to be 2 positions upward or downward on the path P80.

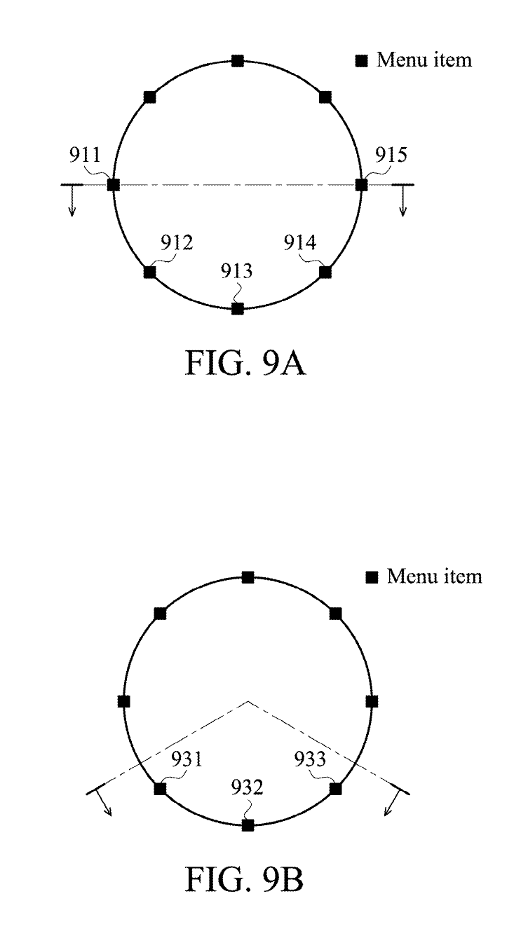

In the spiral cylinder arrangement, the menu items may be further divided into a plurality of launchable menu items and a plurality of non-launchable menu items, wherein the launchable menu items refer to the menu items displayed in the central column on the touch screen 26 and the non-launchable menu items refer to the menu items displayed elsewhere. Alternatively, the launchable menu items may refer to the menu items displayed in a specific area of the virtual cylinder and the non-launchable menu items refer to the menu items displayed in the rest area of the virtual cylinder. The specific area may be predetermined to be the front half of the virtual cylinder from a top view, including positions 911 to 915, as shown in FIG. 9A, or the front sector of the virtual cylinder from a top view, including positions 931 to 933, as shown in FIG. 9B. An additional table may be used to store the information of the to-be-displayed menu items, as shown below in Table 5.

TABLE 5

| Visible | MenuItem | Launchable |
|---|---|---|
| Index | Index | Bit |
| 1 | MenuItem1 | F |
| 2 | MenuItem2 | T |
| 3 | MenuItem3 | F |
| 4 | MenuItem4 | F |
| 5 | MenuItem5 | F |
| 6 | MenuItem6 | F |
| 7 | MenuItem7 | F |
| 8 | MenuItem8 | F |
| 9 | MenuItem9 | F |
| 10 | MenuItem10 | T |
| . | . | . |
| . | . | . |
| . | . | . |

The “Visible Index” field indicates the index of a menu item can be displayed, the “MenuItem Index” field indicates the index of a menu item in Table 3, and the “Launchable Bit” field indicates if a menu item is launchable or non-launchable, where “T” stands for “True” and “F” stands for “False”. Regarding the operation performed in response to one of the menu items being selected by a user, the processing unit 23 may first determine if the selected menu item is launchable. If so, a corresponding application is launched. Otherwise, if the selected menu item is non-launchable, the processing unit 23 performs the upward or downward and clockwise or counter-clockwise movement as described above until the selected menu item is moved to the launchable area on the touch screen 26. After the selected menu item is moved to the launchable area on the touch screen 26, a corresponding application is then launched. Note that the launching of the corresponding application may be manually triggered by a user, or automatically triggered by the processing unit 23.

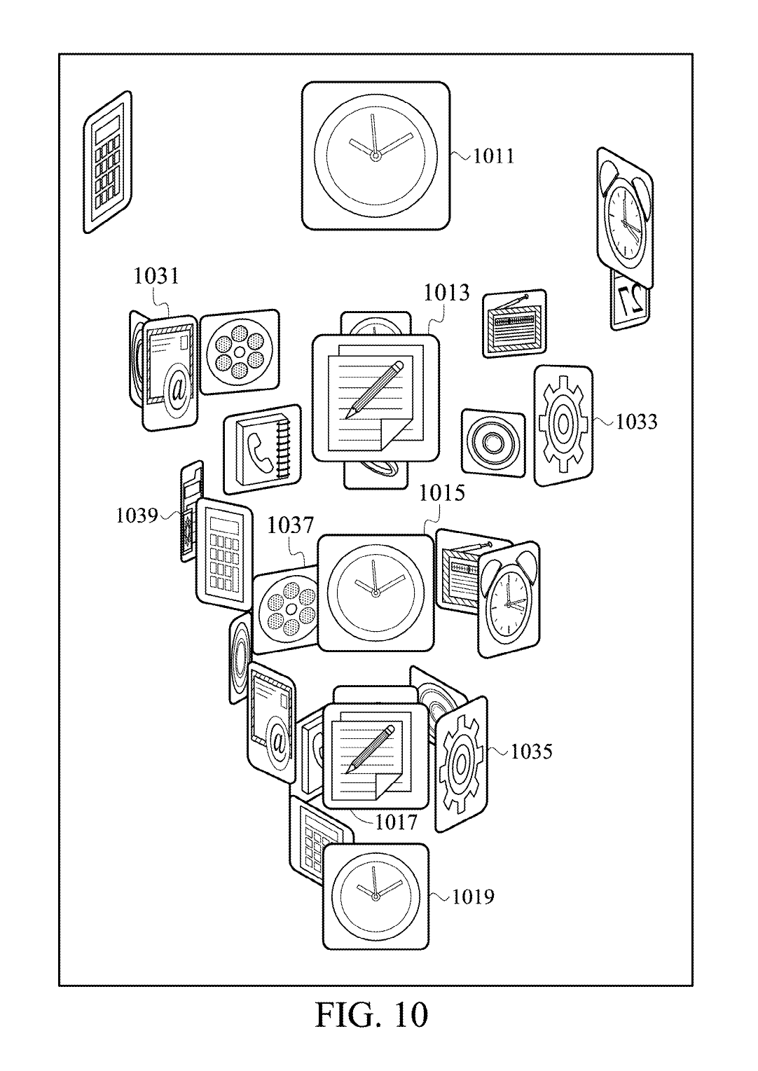

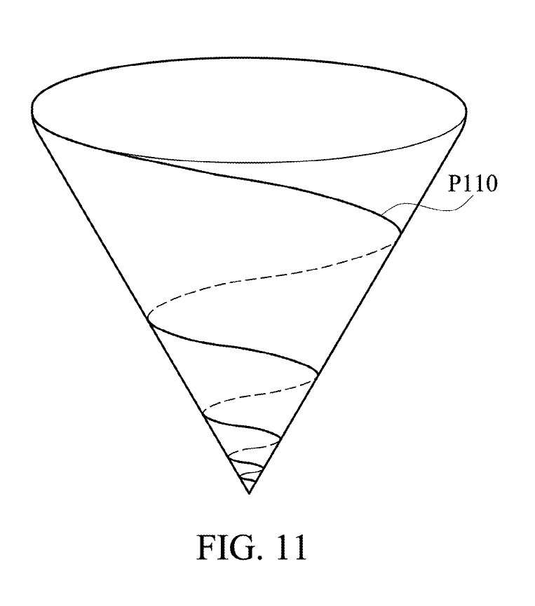

FIG. 10 shows an exemplary arrangement of menu items on the touch screen 26 according to yet another embodiment of the invention. In this embodiment, the menu items are arranged along a clockwise and upward path on a surface of a virtual downward cone. FIG. 11 shows an exemplary path P110 on the surface of a virtual downward cone according to the embodiment shown in FIG. 10. Particularly, the menu items displayed in the central column on the touch screen 26 are flat, for example, icons 1011, 1013, 1015, 1017 and 1019, while the menu items displayed elsewhere are skewed, for example, icons 1031, 1033, 1035, 1037 and 1039, as if the menu items are appended to the surface of the virtual downward cone. The menu items not displayed in the central column on the touch screen 26 are shadowed and/or resized according to the distances from the positions of the menu items in the central column on the touch screen 26. When a user wants to select one of the displayed menu items to launch a corresponding application, he/she may trigger a touch event on the position of the corresponding menu item on the touch screen 26. When the touch screen 26 detects a touch or approximation of an object on or near to one of the displayed menu items, the processing unit 23 launches an application corresponding to the touched or approximated menu item. Later, if the user wishes to view the menu items not displayed on the touch screen 26, he/she simply needs to trigger a drag event, or so-called pen-move event or slide event, on the touch screen 26. When the touch screen 26 detects a continuous touch or approximation of an object thereon, a drag event is identified, and the processing unit 23 determines whether the direction of the drag event is upward or downward. If the direction of the drag event is upward, the processing unit 23 moves all of the displayed menu items upward and clockwise for a distance along the path P110 on the surface of the virtual downward cone. Otherwise, if the direction of the drag event is downward, the processing unit 23 moves all of the displayed menu items downward and counter-clockwise for a distance along the path P110 on the surface of the virtual downward cone. As to the determination of the distance during the upward and downward moving, the processing unit 23 may first determine the duration of how long the drag event had elapsed, and then determine the distance between the original positions of the menu items and the destination positions of the menu items for the upward or downward movement according to a predetermined duration of how long the menu items should be moved from one position to another on the path P110. For example, if the predetermined duration indicates that moving a menu item from one position to another on the path P110 requires 0.2 second and the detected duration of the drag event indicates that the drag event had elapsed for 0.4 second, then the moved distance may be determined to be 2 positions upward or downward on the path P110.

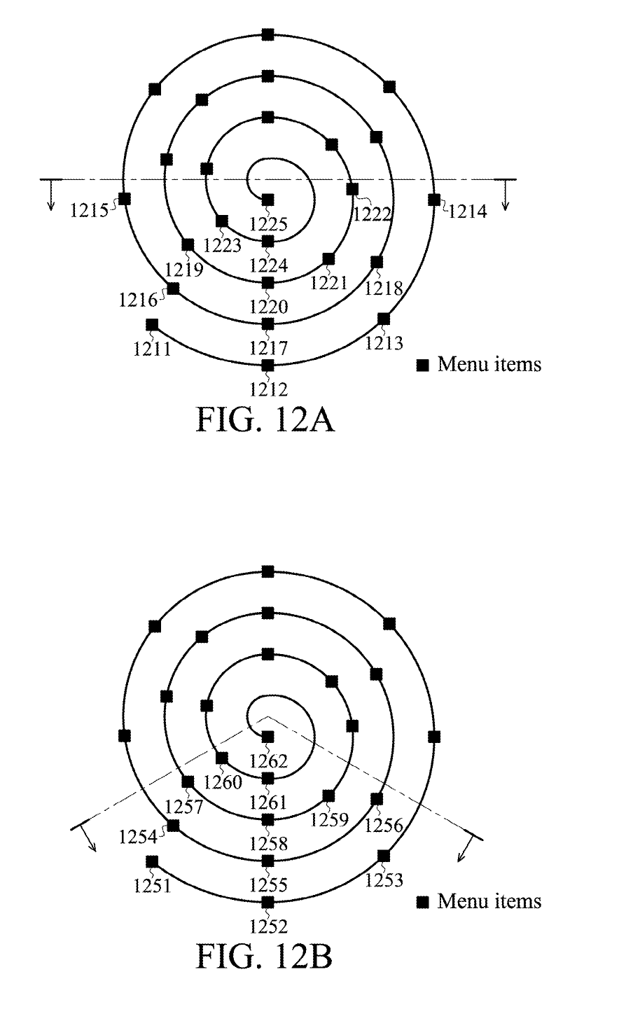

According to the spiral cone arrangement, the menu items may be further divided into a plurality of launchable menu items and a plurality of non-launchable menu items, wherein the launchable menu items refer to the menu items displayed in the central column on the touch screen 26 and the non-launchable menu items refer to the menu items displayed elsewhere. Alternatively, the launchable menu items may refer to the menu items displayed in a specific area of the virtual downward cone and the non-launchable menu items refer to the menu items displayed in the rest area of the virtual downward cone. The specific area may be predetermined to be the front half of the virtual downward cone from a top view, including positions 1211 to 1225, as shown in FIG. 12A, or the front sector of the virtual downward cone from a top view, including positions 1251 to 1262, as shown in FIG. 12B. Regarding the operations performed in response to one of the menu items being selected by the user, the processing unit 23 may first determine if the selected menu item is launchable. If so, a corresponding application is launched. Otherwise, if the selected menu item is non-launchable, the processing unit 23 performs the upward or downward and clockwise or counter-clockwise movement as described above until the selected menu item is moved to the launchable area on the touch screen 26. After the selected menu item is moved to the launchable area on the touch screen 26, a corresponding application is then launched. Note that the launching of the corresponding application may be manually triggered by a user, or automatically triggered by the processing unit 23.

Note that, in the cylinder arrangement in FIG. 7 and the cone arrangement in FIG. 10, the menu items may be configured to be arranged along another path, in an opposite manner. That is, the menu items may be arranged along a clockwise and upward path on the surface of a virtual cylinder, or may be arranged along a counter-clockwise and downward path on the surface of a virtual downward cone. In addition, the path may be configured to be a clockwise or counter-clockwise and upward or downward path on the surface of a different virtual object, such as a virtual upward cone, a virtual spheroid, or others.

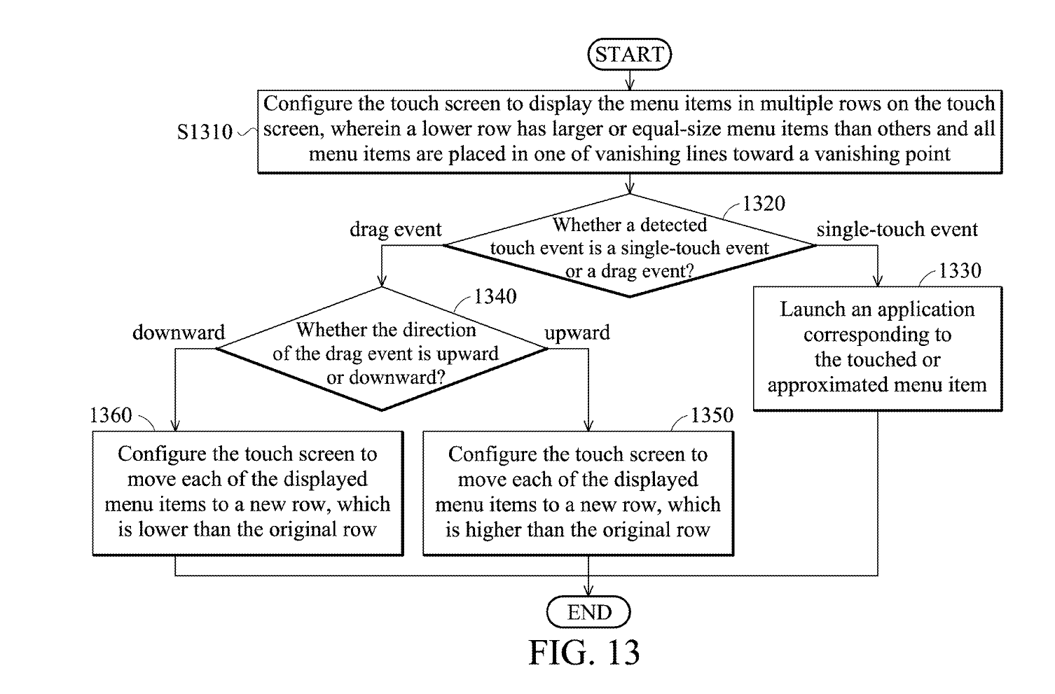

FIG. 13 shows a flow chart of the method for arranging menu items in a virtual 3D space according to an embodiment of the invention. The method may be applied in an electronic apparatus equipped with a touch screen, such as the mobile phone 20, a PMP, a GPS navigation device, a portable gaming console, and so on. Take the mobile phone 20 for example. When the mobile phone 20 is started up, a series of initialization processes, including booting up of the operating system, initializing of the MMI, and activating of the embedded or coupled functional modules (such as the touch screen 26), etc., are performed. After the initialization processes are finished, the MMI is provided via the touch screen 26 for a user to interact with. To begin the method for arranging menu items in a virtual 3D space, the processing unit 23 configures the touch screen 26 to display the menu items in multiple rows on the touch screen 23, wherein a lower row has larger or equal-size menu items than others and all menu items are placed in one of vanishing lines toward a vanishing point (step S1310). That is, taking two rows as an example, as a first row is lower than a second row, the menu items in the second set are smaller than or have equal-size to the menu items in the first set. Specifically, the menu items with the same horizontal sequential order in different rows are arranged in a vanishing line to a vanishing point, so that a virtual 3D space is created with the row arrangement for the user to intuitively and efficiently view the menu items. Exemplary arrangement may refer to FIG. 3.

Later, a touch event is detected on the touch screen 26 and it is determined whether the touch event is a single-touch event or a drag event (step S1320). The touch event may be detected due to one or more touches or approximations of an object on or near to the touch screen 26. If it is a single-touch event, the processing unit 23 launches an application corresponding to the touched or approximated menu item (step S1330). If it is a drag event, the processing unit 23 further determines whether the direction of the drag event is upward or downward (step S1340). If it is an upward drag event, the processing unit 23 configures the touch screen 26 to move each of the displayed menu items to a new row, which is higher than the original row (or is nearer to the far end than the original row in the virtual 3D perspective) (step S1350). For example, the menu items of a first row is moved to a second row, the menu items of the second row is moved to a third row, and so on, in which the first row is higher than the second row (or is closer to the near end than the second row in the virtual 3D perspective) and the second row is higher than the third row (or is closer to the near end than the third row in the virtual 3D perspective), and so on. In addition, the processing unit 23 may further reduce the sizes of the menu items and configures the touch screen 26 to display the reduced menu items in new rows. After the movement, one or more originally displayed higher rows on the touch screen 26, or at the farthest end in the virtual 3D perspective, may be moved out of the touch screen 26 and become invisible, while one or more invisible rows with indices prior to the index of the original bottom visible row, or the originally nearest visible row in the virtual 3D perspective, may be displayed on the bottom of the touch screen 26 and become visible. Otherwise, if it is a downward drag event, the processing unit 23 configures the touch screen 26 to move each of the displayed menu items to a new row, which is lower than the original row (or is nearer to the near end than the original row in the virtual 3D perspective) (step S1360). For example, the menu items of a first row is moved to a second row, the menu items of the second row is moved to a third row, and so on, in which the first row is closer to the far end than the second row, and the second row is closer to the far end than the third row, and so on. In addition, the processing unit 23 may further enlarge the sizes of menu items and configure the touch screen 26 to display the enlarged menu items in new rows. After the movement, one or more originally displayed lower rows on the touch screen 26, or at the nearest end in the virtual 3D perspective, may be moved out of the touch screen 26 and become invisible, while one or more invisible rows with indices subsequent to the index of the original top visible row, or originally farthest visible row in the virtual 3D perspective, may be displayed on the top of the touch screen 26 and become visible. Note that those skilled in the art may modify steps S1350 and S1360 to configure the touch screen 26 to move each of the displayed menu items to a new row, which is higher or lower than the original row, in response to a leftward or rightward drag event, and the invention cannot be limited thereto.

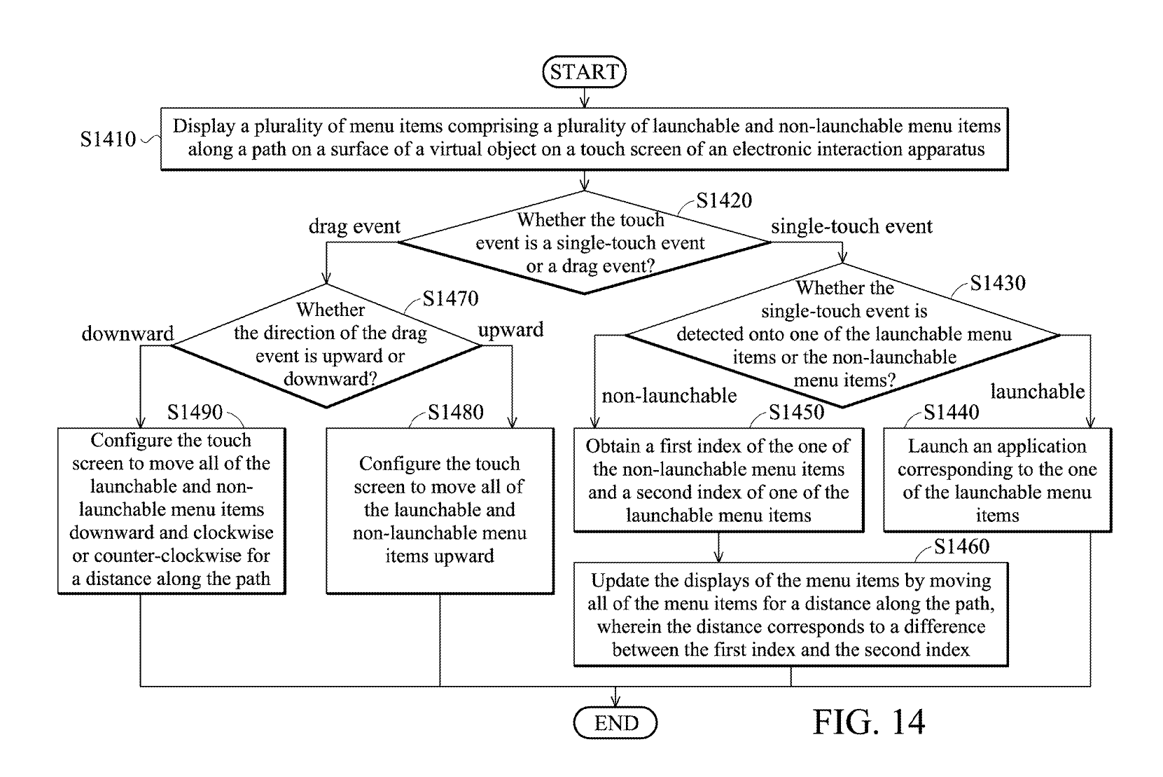

FIG. 14 shows a flow chart of the method for arranging menu items in a 3D virtual space according to another embodiment of the invention. The method may be applied in an electronic apparatus equipped with a touch screen, such as the mobile phone 20, a PMP, a GPS navigation device, a portable gaming console, and so on. Take the mobile phone 20 for example. Similarly, before applying the method, the mobile phone 20 first performs a series of initialization processes upon startup, including booting up of the operating system, initializing of the MMI, and activating of the embedded or coupled functional modules (such as the touch screen 26), etc. To begin the method, the processing unit 23 configures the touch screen 26 to display a plurality of launchable and non-launchable menu items along a path on a surface of a virtual object on a touch screen 26 (step S1410), so that a virtual 3D space is created with the specific arrangement for the user to intuitively and efficiently view the menu items. The virtual object may be a virtual cylinder (as shown in FIG. 7), a virtual downward cone (as shown in FIG. 10), a virtual upward cone, a virtual spheroid, or others, the path may be a clockwise or counter-clockwise and upward or downward path on the surface of the virtual object, and the invention is not limited thereto. The launchable menu items may refer to the menu items displayed in the central column on the touch screen 26 and the non-launchable menu items may refer to the menu items displayed elsewhere. Alternatively, the launchable menu items may refer to the menu items displayed in a specific area of the virtual object and the non-launchable menu items may refer to the menu items displayed in the rest area of the virtual object. For example, if the virtual object is a virtual cylinder, the specific area may be predetermined to be the front half of the virtual cylinder from a top view, including positions 911 to 915, as shown in FIG. 9A, or the front sector of the virtual cylinder from a top view, including positions 931 to 933, as shown in FIG. 9B. If the virtual object is a virtual downward cone, the specific area may be predetermined to be the front half of the virtual downward cone from a top view, as shown in FIG. 12A, including positions 1211 to 1225, or the front sector of the virtual downward cone from a top view, including positions 1251 to 1262, as shown in FIG. 12B.

Next, a touch event is detected on the touch screen 26 and it is determined whether the touch event is a single-touch event or a drag event (step S1420). If it is a single-touch event, the processing unit 23 determines whether the single-touch event is detected on one of the launchable menu items or the non-launchable menu items (step S1430). If the single-touch event is detected on one of the launchable menu items, the processing unit 23 launches an application corresponding to the one of the launchable menu items (step S1440). If the single-touch event is detected on one of the non-launchable menu items, the processing unit 23 obtains a first index of the one of the non-launchable menu items and a second index of one of the launchable menu items (step S1450). After that, the processing unit 23 configures the touch screen 26 to move the launchable and non-launchable menu items for a distance along the path corresponding to a difference between the first index and the second index (step S1460). After the updating of the displays of the menu items, the one of the non-launchable menu items is configured as launchable and the processing unit 23 may continue to launch the application corresponding to the configured menu item, or the user may need to trigger another single-touch event on the configured menu item to launch the corresponding application. Subsequent to step S1420, if the touch event is a drag event, the processing unit 23 determines whether the direction of the drag event is upward or downward (step S1470). If it is an upward drag event, the processing unit 23 configures the touch screen 26 to move all of the launchable and non-launchable menu items upward and clockwise or counter-clockwise for a distance along the path (step S1480). Otherwise, if it is a downward drag event, the processing unit 23 configures the touch screen 26 to move all of the launchable and non-launchable menu items downward and clockwise or counter-clockwise for a distance along the path (step S1490). Note that during the moving of the launchable and non-launchable menu items, the menu items not to be displayed in the launchable area on the touch screen 26 may be shadowed and/or resized.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An electronic interaction apparatus for arranging a plurality of menu items in a virtual 3D space, comprising:
a processing unit configuring a touch screen to display a first set of the menu items in a first row on the touch screen, and to display a second set of the menu items in a second row on the touch screen,
wherein the first row is lower than the second row, and the menu items in the second set are smaller than the menu items in the first set.

2. The electronic interaction apparatus of claim 1, wherein the processing unit further configures the touch screen to display the menu items with the same horizontal sequential order in the first row and the second row to be arranged in a vanishing line to a vanishing point.

3. The electronic interaction apparatus of claim 1, wherein the processing unit further detects a touch or approximation of an object on or near to one of the displayed menu items on the touch screen, and launches an application corresponding to the touched or approximated menu item.

4. The electronic interaction apparatus of claim 1, wherein the processing unit further reduces the sizes of the menu items in the first and second sets, and configures the touch screen to move the first set of the reduced menu items to the second row and the second set of the reduced menu items to a third row, respectively, in response to detecting an upward movement of a touch or approximation of an object on the touch screen, and the second row is lower than the third row.

5. The electronic interaction apparatus of claim 1, wherein the processing unit further enlarges the sizes of menu items in the second set and a third set, and configures the touch screen to move the second set of the enlarged menu items to the first row to replace the first set of the menu items and to move the third set of the enlarged menu items to the second row, in response to detecting a downward movement of a touch or approximation of an object on the touch screen.

6. A method for arranging a plurality of menu items in a virtual 3D space, comprising:
displaying a first set of the menu items in a first row on a touch screen of an electronic interaction apparatus; and
displaying a second set of the menu items in a second row on the touch screen,
wherein the first row is lower than the second row, and the menu items in the second set are smaller than the menu items in the first set.

7. The method of claim 6, wherein the menu items with the same horizontal sequential order in the first row and the second row are arranged in a vanishing line to a vanishing point.

8. The method of claim 6, further comprising detecting a touch or approximation of an object on or near to one of the displayed menu items, and launching an application corresponding to the touched or approximated menu item.

9. The method of claim 6, further comprising moving the first set and the second set of the menu items to new rows in response to detecting an upward or downward movement of a touch or approximation of an object on the touch screen.

10. The method of claim 9, wherein moving distances for the first and second sets of menu items are calculated according to how long the upward or downward movement had elapsed.

11. An electronic interaction apparatus for arranging menu items in a virtual 3D space, comprising:
a processing unit detecting a touch or approximation of an object on a touch screen, configuring the touch screen to display a plurality of menu items, and launching an application corresponding to one of the menu items in response to the touch or approximation of the object being detected on or near to the one of the menu items, wherein the menu items are arranged along a clockwise or counter-clockwise and upward or downward path on a surface of a virtual object.

12. The electronic interaction apparatus of claim 11, wherein the processing unit further configures the touch screen to move all of the menu items upward and clockwise or counter-clockwise for a distance along the path, in response to detecting an upward movement of the touch or approximation of the object on the touch screen.

13. The electronic interaction apparatus of claim 11, wherein the processing unit further configures the touch screen to move all of the menu items downward and clockwise or counter-clockwise for a distance along the path, in response to detecting a downward movement of the touch or approximation of the object on the touch screen.

14. The electronic interaction apparatus of claim 11, wherein the virtual object is a virtual cylinder or a virtual cone.

15. A method for arranging menu items in a virtual 3D space, comprising:
displaying a plurality of menu items on a touch screen of an electronic interaction apparatus; and
launching an application corresponding to one of the menu items in response to the touch or approximation of the object being detected on or near to the one of the menu items,
wherein the menu items are arranged along a clockwise or counter-clockwise and upward or downward path on a surface of a virtual object.

16. The method of claim 15, further comprising updating the displays of the menu items by moving all of the menu items upward or downward and clockwise or counter-clockwise for a distance along the path, in response to detecting a movement of the touch or approximation of the object on the touch screen.

17. The method of claim 16, wherein moving distances for the menu items are calculated according to how long the movement had elapsed.

18. An electronic interaction apparatus for arranging menu items in a virtual 3D space, comprising:
a processing unit detecting a touch or approximation of an object on a touch screen, displaying a plurality of launchable and non-launchable menu items along a path on a surface of a virtual object on the touch screen, launching an application corresponding to one of the launchable menu items in response to the touch or approximation of the object being detected on or near to the one of the launchable menu items, and configuring the touch screen to move all of the launchable and non-launchable menu items for a distance along the path in response to the touch or approximation of the object being detected on or near to one of the non-launchable menu items.

19. The electronic interaction apparatus of claim 18, wherein the processing unit further configures the touch screen to move the touched or approximated non-launchable menu item to a launchable area in response to the touch or approximation of the object being detected on or near to the one of the non-launchable menu items.

20. The electronic interaction apparatus of claim 19, wherein the processing unit further launches an application corresponding to the touched or approximated non-launchable menu item after the touched or approximated non-launchable menu item is moved to the launchable area.

21. A method for arranging menu items in a virtual 3D space, comprising:
displaying a plurality of launchable and non-launchable menu items along a path on a surface of a virtual object on a touch screen of an electronic interaction apparatus;
launching an application corresponding to one of the launchable menu items in response to a touch or approximation of an object being detected on or near to the one of the launchable menu items;
obtaining a first index of one of the non-launchable menu items in response to the touch or approximation of the object being detected on or near to the one of the non-launchable menu items;
obtaining a second index of one of the launchable menu items for the one of the non-launchable menu items; and
moving all of the launchable and non-launchable menu items for a distance along the path corresponding to a difference between the first index and the second index.
